(19) United States
(12) Patent Application Publication
(10) Pub. No.: US 2010/0090853 A1
(43) Pub. Date: Apr. 15, 2010

(54) VISUAL-PROTECTIVE WARNING APPARATUS

(75) Inventors: Shey-Shi Lu, Taipei (TW); Kai-Wen Yeh, Taipei (TW); Yi-Chin Lee, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: National Taiwan University, Taipei City (TW)

(21) Appl. No.: 12/471,766

(22) Filed: May 26, 2009

(30) Foreign Application Priority Data
Oct. 14, 2008 (TW) 097139388

(51) Int. Cl. G08B 21/00

(52) U.S. Cl. 340/686.6

(57) ABSTRACT

The present invention relates to a visual-protective warning apparatus and more particularly to a visual-protective warning apparatus that prevents the distance between a person's eyes and a visual object being too close to each other. The visual-protective warning apparatus comprises a transmitter and a receiver The transmitter is mounted on a person and transmits a wireless signal. The receiver has a warning indicator that is activated when RSSI of the wireless signal from the transmitter exceeds a threshold.

### FIELD OF THE INVENTION

The present invention relates to a visual-protective warning apparatus and more particularly to a visual-protective warning apparatus that activates an alarm when an object is too close to a person's eyes.

### BACKGROUND OF THE INVENTION

According to market analysis projections of the Market Intelligence Center (MIC) of the Institute for Information Industry in Taiwan, people will spend more than ten billion New Taiwan dollars or roughly three hundred million US dollars playing online games in 2008. The market is projected to grow to 12 billion New Taiwan dollars or more than 360 million US dollars in 2010, and the largest group of people includes not only students but also white-collar workers.

However, online game business is only a part of online business. Other services that also attract many people include blogs, chat rooms, and electronic albums. People accessing online services often spend many consecutive hours reading other people's diaries or stories or looking at photos, which may result in a person getting too close to a computer screen, printed material or an object that needs to be perused or studied closely and suffering from eye strain or posture related disorders.

Therefore, an invention is needed that will reduce the likelihood of damage to a person's eyes and promote good posture.

### SUMMARY OF THE INVENTION

The objective of a visual-protective warning apparatus in accordance with the present invention is to reduce the likelihood of damage to a person's eyes and promote good posture.

A visual-protective warning apparatus in accordance with the present invention that prevents the distance between a person's eyes and a visual object being too close to each other comprises a transmitter and a receiver. The transmitter is mounted on a person and transmits a wireless signal. The receiver has a warning indicator that is activated when RSSI of the wireless signal from the transmitter exceeds a threshold.

A visual-protective warning apparatus in accordance with present invention comprises an indicator, at least one wireless module and a power module.

### BRIEF DESCRIPTIONS OF THE DRAWINGS

FIG. 1 is an operational perspective view of a visual-protective warning apparatus in accordance with the present invention mounted on a person reading a book and the book;

FIG. 2 is a functional block diagram of a receiver of the visual-protective warning apparatus in FIG. 1;

FIG. 3 is a functional block diagram of a transmitter of the visual-protective warning apparatus in FIG. 1;

FIG. 4 is an operational perspective view of a visual-protective warning apparatus mounted on a person using a computer and the computer.

### DETAILED DESCRIPTION OF THE PRESENT INVENTION

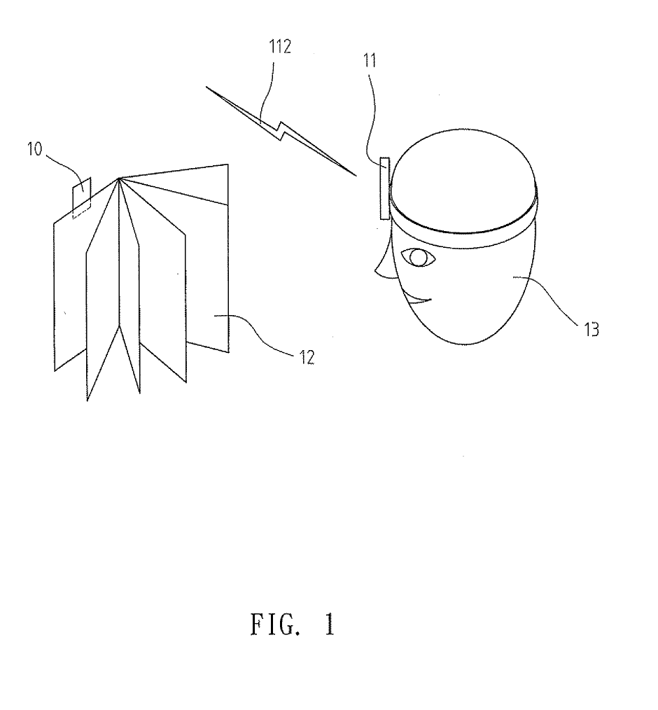

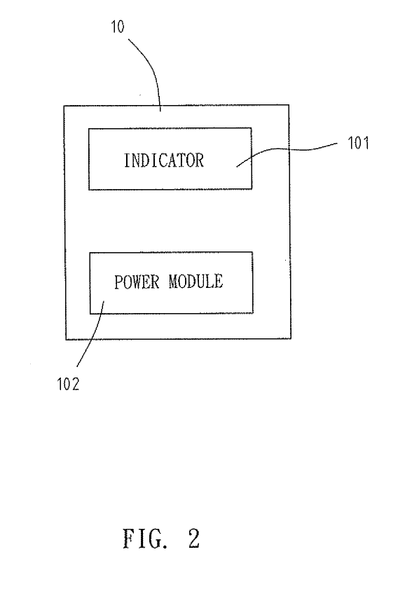

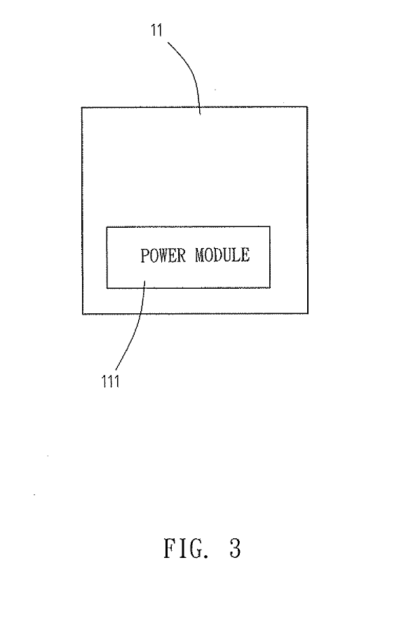

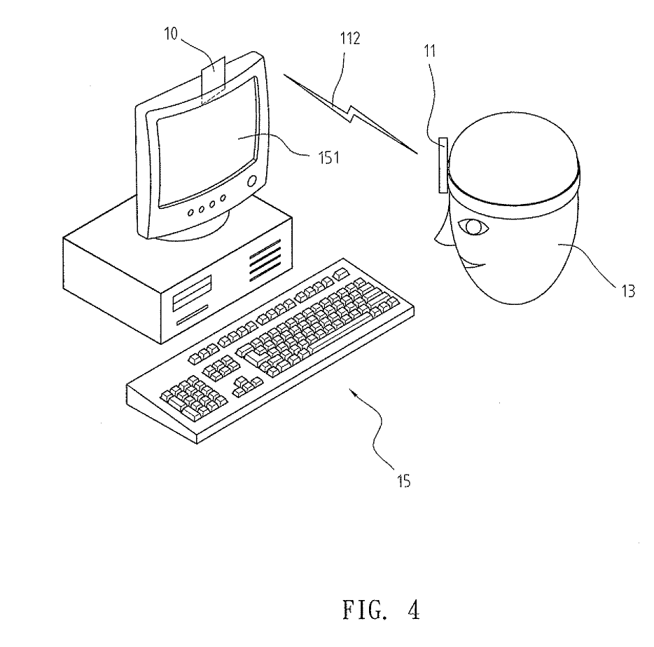

With reference to FIGS. 1 to 4, a visual-protective warning apparatus in accordance with the present invention is used to prevent eye damage and improve posture when a person reads a book (12) or other printed material, uses a computer (15) with a monitor (151) or closely scrutinizes or studies visually any object and comprises a transmitter (11) and a receiver (10).

The transmitter (11) is a wireless module, may be an MSP430 microcontroller, is worn on a person's (13) forehead, transmits a wireless signal (112) that may be an IEEE 802.15.4/ZigBee protocol and has a power module (111).

The power module (111) provides DC power to operate the transmitter (11) and comprises a battery assembly, an optional USB plug and an optional AC assembly.

The battery assembly is mounted in the transmitter (11) and comprises a battery compartment and at least one battery. The battery compartment is formed inside the transmitter (11).

The batteries are mounted removably in the battery compartment and provide DC power to operate the transmitter (11).

The USB plug extends through the transmitter (11) and provides DC power to drive the transmitter (11) when plugged into an active USB connector such as a USB connector on an operating computer (15).

The AC assembly comprises a rectifier and an electric cord. The rectifier is mounted in the transmitter (11), converts AC to DC power and provides DC power to drive the transmitter (11).

The electric cord connects to the rectifier, extends from the transmitter (11) and selectively connects to an external AC power source.

The receiver (10) is a wireless module, may be an MSP430 microcontroller, is mounted on a book (12), other printed material, a monitor (151) or any object, senses a received signal strength indication (RSSI) of the wireless signal (112) from the transmitter (11), determines how far the transmitter (11) is from the receiver (10) based on RSSI and comprises a warning indicator (101) and a power module (102).

The warning indicator (101) is mounted in the receiver (10), provides a warning indication when the person (13) wearing the transmitter (11) is close enough to the receiver (10) to cause the RSSI to exceed a threshold such as an RSSI greater than 200 and may be a vibrator, a light, a buzzer or a speaker.

The power module (102) provides DC power to operate the receiver (10) and the warning indicator (101) and comprises a battery assembly, an optional USB plug and an optional AC assembly.

The battery assembly is mounted in the receiver (10), is connected to the warning indicator (101) and comprises a battery compartment and at least one battery.

The battery compartment is formed inside the receiver (10).

The batteries are mounted removably in the battery compartment and provide DC power to operate the receiver (10) and the indicator (101).

The USB plug extends through the receiver (10) and provides DC power to drive the receiver (10) and the warning indicator (101) when plugged into an active USB connector such as a USB connector on an operating computer (15).

The AC assembly comprises a rectifier and an electric cord. The rectifier is mounted in the receiver (10), converts AC to DC power, is connected to the warning indicator (101) and provides DC power to drive the receiver (10) and the warning indicator (101).

The electric cord connects to the rectifier, extends from the receiver (10) and selectively connects to an external AC power source.

People skilled in the art will understand that various changes, modifications and alterations in form and details may be made without departing from the spirit and scope of the invention.

What is claimed is:

1. A visual-protective warning apparatus comprising
At least one wireless module being located near eyes of a person or a position where the person being looked at, receiving a wireless signal and getting the distance between eyes and the position, and alarming when the distance being smaller than the value of a safe distance for eyes.

2. The visual-protective warning apparatus as claimed in claim 1, wherein
a couple of wireless modules being responsible for transmitting and receiving, being located respectively near eyes and the position where eyes being looked at and comprising
a transmitter; and
a receiver sensing a signal of the wireless signal from the transmitter and determining distance between wireless modules.

3. The visual-protective warning apparatus as claimed in claim 1, wherein
a wireless modules being responsible for both transmitting and receiving, according to time difference of arrival, determining the distance between eyes and the position where eyes being looked at.

4. The visual-protective warning apparatus as claimed in claim 2, wherein the wireless modules being mounted respectively on a visual object and near eyes and further comprising
a warning indicator being mounted in the wireless module and providing a warning indication when a person being close enough to the wireless module to cause the received RSSI value to exceed a threshold.

5. The visual-protective warning apparatus as claimed in claim 4, wherein the RSSI threshold that activates the warning indicator is a RSSI value corresponding to the value of safe distance for eyes.

6. The visual-protective warning apparatus as claimed in claim 4, wherein the warning indicator is a vibrator.

7. The visual-protective warning apparatus as claimed in claim 5, wherein the warning indicator is a vibrator.

8. The visual-protective warning apparatus as claimed in claim 4, wherein the warning indicator is a light.

9. The visual-protective warning apparatus as claimed in claim 5, wherein the warning indicator is a light.

10. The visual-protective warning apparatus as claimed in claim 4, wherein the warning indicator is a buzzer.

11. The visual-protective warning apparatus as claimed in claim 5, wherein the warning indicator is a buzzer.

12. The visual-protective warning apparatus as claimed in claim 4, wherein the warning indicator is a speaker.

13. The visual-protective warning apparatus as claimed in claim 5, wherein the warning indicator is a speaker.
